(19) United States
(12) Patent Application Publication
(10) Pub. No.: US 2004/0128653 A1
(43) Pub. Date: Jul. 1, 2004

(54) Methods and processes for validating reports

(75) Inventor: Jean-Francois Arcand, Prevost (CA)

Correspondence Address: MARTINE & PENILLA, LLP, 710 LAKEWAY DRIVE, SUITE 170, SUNNYVALE, CA, 94085, US

(73) Assignee: Sun Microsystems, Inc.

(21) Appl. No.: 10/334,630

(22) Filed: Dec. 31, 2002

(51) Int. Cl. G06F 9/44

(52) U.S. Cl. 717/124

(57) ABSTRACT

A method for generating accurate test execution results in accordance with a release structure is provided. The method includes receiving the test execution results and inspecting the test execution results to create validated test execution results. The method also includes rejecting the validated test execution results back to an original owner to enable re-validation while the validated test execution results fail to satisfy a particular criteria. The method also includes releasing the validated test execution results to the next level in the release structure if the validated test execution results are acceptable and while a next level in the release structure exists. Also included in the method is rejecting the validated test execution results to the original owner if the validated test execution results are unacceptable. The method further includes posting the validated test execution results that were determined to be acceptable.

### BACKGROUND OF THE INVENTION

1. Field of the Invention

The present invention relates generally to software testing, and more particularly, to methods and processes for improving report generation.

2. Description of the Related Art

As the use of computer software in performing daily tasks is increasing rapidly, assessing software reliability through software testing has become an imperative stage in the software development cycle. As is well known, software testing is directed toward eliminating defects (i.e., bugs) in computer software, which if undetected, can create significant negative results.

Typically, computer software development involves multiple groups of developers and engineers, with the members of each group being responsible for developing a certain portion of the computer software source code (i.e., workspace). Members of each group are further responsible for ensuring that the group workspace functions properly, which for the most part, is achieved through testing the group's workspace. Usually, by the conclusion of testing process, workspace testing results in the generation of multiple reports, each containing test execution results.

Predominantly, test execution results are generated manually by the members of the groups, such as the engineers and developers. Despite being used extensively, manual generation of test execution results has several disadvantages. By way of example, manual generation of test execution results can inject inaccurate and erroneous data into test execution results. Exemplary inaccurate and erroneous data ranging from typographical errors, execution of improper tests, or incorrectly collecting generated data. Eliminating any of these introduced errors is a tedious and time-consuming task, wasting the developers and engineers' valuable time while significantly and unnecessarily lengthening software development cycle.

Another disadvantage of the current test execution result report generation is that all test execution failures should be identified and removed prior to generating test execution result reports, and all test execution failures and successes recalculated. As a consequence, the members of the group must perform yet another repetitive and lengthy task.

Furthermore, reviewing manually generated test execution results does not provide adequate information as to whether a complete and accurate testing process has been performed. Consequently, to achieve this task, test execution results must be manually re-entered into a computerized system, marking yet another limitation of the current test execution result report generation.

Failing to meet managers as well as developers and engineers' expectations is still another disadvantage of manually generating test execution results report. For instance, currently, test execution results are not provided to the managers in a timely manner. Rather, the managers receive test execution results reports after each and every member of the group has reviewed the member's test result reports and removed any existing execution and script failures. As a result, the managers have no other alternative but to wait for an extended period of time to receive test execution results. Therefore, manually generating test execution results significantly lowers the quality and efficiency of the managers, notably increasing the software development cycle.

Furthermore, the engineer and developer members of the group must be able to easily modify their respective test result reports before submitting same to the managers. For instance, the engineer and developer members must be able to remove or correct information or add comments to the test result reports before making the test result reports available to the managers. Again, manually generating test execution results makes this task rather time-consuming and exhaustive, resulting in engineer and developer members' waste of time.

In view of the foregoing, there is a need for a flexible methodology and process for improving generation of accurate and timely reports.

### SUMMARY OF THE INVENTION

Broadly speaking, the present invention fills these needs by providing a process and method for generating accurate and timely validated reports incorporating a validation release structure. In one embodiment, test execution results generated as a result of testing a computer software application using a test suite/test case are validated by each member of a group in accordance with a validation release structure. The group validated test execution results are posted, causing the test results to have a non-changeable status. The posted test execution results are implemented to generate validated test execution results reports. It should be appreciated that the present invention can be implemented in numerous ways, including as a process, an apparatus, a system, a device, or a method. Several inventive embodiments of the present invention are described below.

In one embodiment, a method for generating accurate test execution results in accordance with a release structure is provided. The method includes receiving the test execution results and inspecting the test execution results to create validated test execution results. The method also includes rejecting the validated test execution results back to an original owner to enable re-validation while the validated test execution results fail to satisfy a particular criteria. The method also includes releasing the validated test execution results to the next level in the release structure if the validated test execution results are acceptable and while a next level in a release structure exists. Also included in the method is rejecting the validated test execution results to the original owner if the validated test execution results are unacceptable. The method further includes posting validated test execution results that were determined to be acceptable.

In another embodiment, a method for validating results through an inspection hierarchy is provided. The method includes receiving the results and inspecting the results to create validated results at a first level while maintaining an exclusive ownership of the results at the first level. The method also includes releasing the validated results to the second level in the release structure if the validated results are acceptable at the first level and as long as a second level in a release structure exists. The method further includes rejecting the validated results if the validated results are unacceptable and as long a the second level in the release structure exits. The rejecting at the second level acts to send the results back to the first level. The method further includes posting the validated results if determined to be acceptable at the second level.

In yet another embodiment, a computer program embodied on a computer readable medium for validating results through an inspection hierarchy is provided. The computer program includes program instructions for receiving the results. The computer program further includes program instructions for inspecting the results to create validated results at a first level, while the first level maintains an exclusive ownership of the results. Also included in the program instructions are program instructions for releasing the validated results to the second level in the release structure as long a second level in the release structure exists and the validated results are acceptable at the first level. The computer program also includes program instructions for rejecting the validated results as long as the second level in the release structure exists and the validated results are unacceptable. The rejecting at the second level acts to send the results back to the first level. The computer program also includes program instructions for posting the validated results if determined to be acceptable at the second level.

In still another embodiment, a method for validating results through an inspection hierarchy is provided. The method includes receiving the results and inspecting the results to create validated results at a first level of a plurality of level while at the first level an exclusive ownership of the results is maintained. The method further includes releasing the validated results to a first remaining level of the remaining level of the plurality of levels in the release structure if the validated results are acceptable at the first level of the plurality of levels and as long as a remaining level of the plurality of levels in a release structure exists. The method also includes rejecting the validated results if the validated results are unacceptable and as long as the remaining level of the plurality of levels in the release structure exists. The rejecting at the remaining level of the plurality of levels acts to send the results back to the first level. The method also includes posting the validated results if determined to be acceptable at the remaining level of the plurality of levels.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic diagram illustrating generation of validated test execution results using a validation release structure, in accordance with one embodiment of the present invention.

FIG. 2 is a simplified block diagram of an exemplary validation process, in accordance with another embodiment of the present invention.

FIG. 3A is a simplified block diagram of an exemplary group hierarchy, in accordance with still another embodiment of the present invention.

FIG. 3B is a simplified schematic diagram of an exemplary group release, in accordance with still another embodiment of the present invention.

FIGS. 4A-4K are simplified block diagrams illustrating different stages of an exemplary validation process implemented by members of an exemplary group, in accordance to yet another embodiment of the present invention.

FIG. 5 depicts an exemplary validation process, in accordance with yet another embodiment of the present invention.

FIG. 6 depict an exemplary validation process, in accordance with still another embodiment of the present invention.

FIG. 7 is a flow chart diagram illustrating a method operations performed during an exemplary validation process, in accordance with yet another embodiment of the present invention.

FIG. 8 is a flow chart diagram illustrating a method operations performed in an exemplary validation process implementing a filter, in accordance with still another embodiment of the present invention.

FIG. 9 is a flow chart diagram illustrating a method operations performed by a group manager during an exemplary validation process, in accordance with yet another embodiment of the present invention.

### DETAILED DESCRIPTION OF THE PREFERRED EMBODIMENTS

Inventions for simplifying generation of validated reports implementing a validation release structure are provided. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

In one embodiment of the present invention, test execution results generated by testing a computer software application using a test suite/test case are validated by each member of a group in accordance with a validation release structure. The group validated test execution results are posted causing the test execution results to have a non-changeable status. The posted test execution results are implemented to generate validated test execution results reports.

The validation process is initiated by providing the test execution results to the test suite/test case creator (i.e., owner of the test suite/test case) for review and modification, if necessary. At this point, the owner may either reject the test execution results due to the test execution results including unexpected results (e.g., bugs) or release (i.e., validate) the test execution results to the next individual in the release structure. In rejecting the test execution results, if necessary, the owner can modify the test execution results subsequent to which the modified test execution results can be released. In this manner, each member of the release structure is given an opportunity to review the test execution results and to either validate or reject same. In one embodiment, the embodiments of the present invention are result auditing, herein defined as a scenario wherein a flow of the results is driven by a release structure.

As one embodiment of the present invention implements the Enterprise JavaBeans (EJB) application, a brief introduction to EJB architecture is provided below. EJB is part of a larger overall technology known as the Java 2 Platform, Enterprise Edition (J2EE) developed by Sun Microsystems, Inc. J2EE provides architecture for developing, deploying, and executing applications in a distributed-object environment.

Summarily, EJB architecture promotes the creation of re-usable server-side behaviors or instructions in the Java language, connectors to enable access to existing enterprise systems, and easy-to-deploy program modules. The EJB architecture creates a collaborative architecture to provide services virtually anywhere, and for a wide range of customers and devices.

The EJB architecture defines a model for the development and deployment of reusable Java server components called EJB components (i.e., EJB beans). As designed, the EJB component is a non-visible server component having methods that provide business logic in a distributed application. In one example, the EJB architecture includes the EJB client and the EJB server. The EJB client is configured to provide the user-interface logic on a client machine and to make calls to remote EJB components on a server. For instance, the EJB client is provided the information as to how to find the EJB server and how to interact with the EJB components.

In one example, the EJB client does not communicate directly with the EJB component. In one aspect, the EJB container provides the client proxy objects that implement the home and remote interfaces of the component. In one example, the remote interface is configured to define the business methods that can be called by the client. In another embodiment, the client is configured to invoke the methods resulting in the updating of the database. Thus, the EJB beans are reusable components that can be accessed by client programs. The application programmer codes the business logic into the EJBs and deploys them into a J2EE compliant server. In one example, the server complying with the J2EE specification provides the required system-level services, thus allowing the application programmer to concentrate on business logic.

The EJB server (i.e., the EJB application) includes an EJB container, which in one example provides the services required by the EJB component. For instance, the EJB container may be configured to include one of an EJB home interface or EJB Remote interface and EJB beans. In one embodiment, the EJB home interface and the EJB remote interface are defined in the same Java virtual machine. In a different embodiment, the EJB home interface and the EJB remote interface may be defined on different Java virtual machines or separate physical computers.

In one example, the EJB specification defines a container as the environment in which one or more EJB components execute. In accordance to one example, the EJB container provides the infrastructure required to run distributed components thus allowing the clients and component developers to focus on programming business logic. Simply stated, the container manages the low-level communications between the clients and the EJB beans. In one example, once an EJB bean is created by a client, the client invokes methods on the EJB bean as if the EJB bean were running in the same virtual machine as the client.

Furthermore, the clients are unaware of activities on the EJB bean, since the container is configured to sit between the clients and the EJB beans. For instance, if an EJB bean is passivated, its remote reference on the client remains intact. Thus, when the client later invokes a method on the remote reference, the container activates the EJB bean to service the request.

The EJB container encapsulates:

The client runtime and generated sub classes. In one example, this allows the client to execute components on a remote server as if the components were local objects.

The naming service allows the clients to instantiate components by name. It further allows components to obtain resources (e.g., database connections, etc.) by name.

The EJB server component dispatcher, which in one example, executes the component's implementation class and provides services such as transaction management, database connection pooling, and instance lifecycle management.

In one example, three types of EJB components can be enumerated.

Stateful session Beans: A stateful session bean manages complex processes or tasks that require the accumulation of data. They further manage tasks that require more than one method call to complete but are relatively short lived, store session state information in class instance data, and have an affinity between each instance and one client from the time the client creates the instance until it is destroyed by the client or by the server.

Stateless session Beans: A stateless session bean manages tasks that do not require the keeping of client session data between method calls. Furthermore, the method invocation by a stateless session bean does not depend on data stored by previous method invocations, there is no affinity between a component instance and a particular client, and different instances of the stateless session beans are seemed identical to the client.

Entity Beans: An entity bean model is a business model that is a real-world object which methods are run on the server machine. When the entity bean method is called, the program's thread stops executing and control is passed to the server. When the method returns from the server, the local thread resumes executing. In one example, the entity beans have the following characteristics: Each instance represents a row in a persistent database relation (e.g., a table, view, etc.); and The bean has a primary key that corresponds to the database relation's key which is represented by a Java data type or class.

Each EJB component further has a transaction attribute configured to determine the manner the instances of the component participate in transactions. As designed, the EJB container provides services which can include transaction and persistence support to the EJB components. As to the transaction support, the EJB container is configured to support transactions. In one example, when the bean is deployed, the EJB container provides the necessary transaction support. In regard to the persistence support, the EJB container is configured to provide support for persistence of the EJB components, which in one embodiment, is defined as the capability of the EJB component to save and retrieve its state. In this manner, the EJB component does not have to be re-created with each use.

In one example, the EJB architecture is a three-tiered architecture in which the clients reside on the first tier, the application server and the components (i.e., EJB beans) reside on the second tier, and the databases reside on the same host as the EJB server. In accordance to one implementation, the EJB server executes methods on a component from the client or another component, retrieves data from databases, and performs other communications. The EJB server further handles the details of transactions, threads, security, database connections, and network communication. Summarily, the EJB clients request business-logic services from EJB beans running on the second-tier. The EJB beans then use the system services provided by the second-tier server to access data from existing systems in the third tier. The EJB beans apply the business rules to the data, and return the results to the clients in the first-tier.

In one example, the client contains the user interface. The business logic is configured to be separate from both the clients and the databases and resides in the same tier (i.e., second tier) as components that analyze data, perform computations, or retrieve information from data sources and processes.

As EJB implements the Java™ (hereinafter “Java”) programming language, in a like manner, an overview of Java is provided below. In operation, a user of a typical Java based system interacts with an application layer of a system generally written by a third party developer. The application layer generally provides the user interface for the system. A Java module is used to process commands received by the application layer. A Java virtual machine is used as an interpreter to provide portability to Java applications. In general, developers design Java applications as hardware independent software modules, which are executed Java virtual machines. The Java virtual machine layer is developed to operate in conjunction with the native operating system of a particular hardware, which represents the physical hardware on which the system operates or runs. In this manner, Java applications can be ported from one hardware device to another without requiring updating of the application code.

Unlike most programming languages, in which a program is compiled into machine-dependent, executable program code, Java classes are compiled into machine independent byte code class files which are executed by a machine-dependent virtual machine. The virtual machine provides a level of abstraction between the machine independence of the byte code classes and the machine-dependent instruction set of the underlying computer hardware. A class loader is responsible for loading the byte code class files as needed, and an interpreter or just-in-time compiler provides for the transformation of byte codes into machine code.

More specifically, Java is a programming language designed to generate applications that can run on all hardware platforms, small, medium and large, without modification. Developed by Sun, Java has been promoted and geared heavily for the Web, both for public Web sites and Intranets. Generally, Java programs can be called from within HTML documents or launched standalone. When a Java program runs from a Web page, it is called a “Java applet,” and when run on a Web server, the application is called a “servlet.”

Java is an interpreted language. The source code of a Java program is compiled into an intermediate language called “byte code”. The byte code is then converted (interpreted) into machine code at runtime. Upon finding a Java applet, the Web browser invokes a Java interpreter (Java Virtual Machine), which translates the byte code into machine code and runs it. Thus, Java programs are not dependent on any specific hardware and will run in any computer with the Java Virtual Machine software. On the server side, Java programs can also be compiled into machine language for faster performance. However a compiled Java program loses hardware independence as a result.

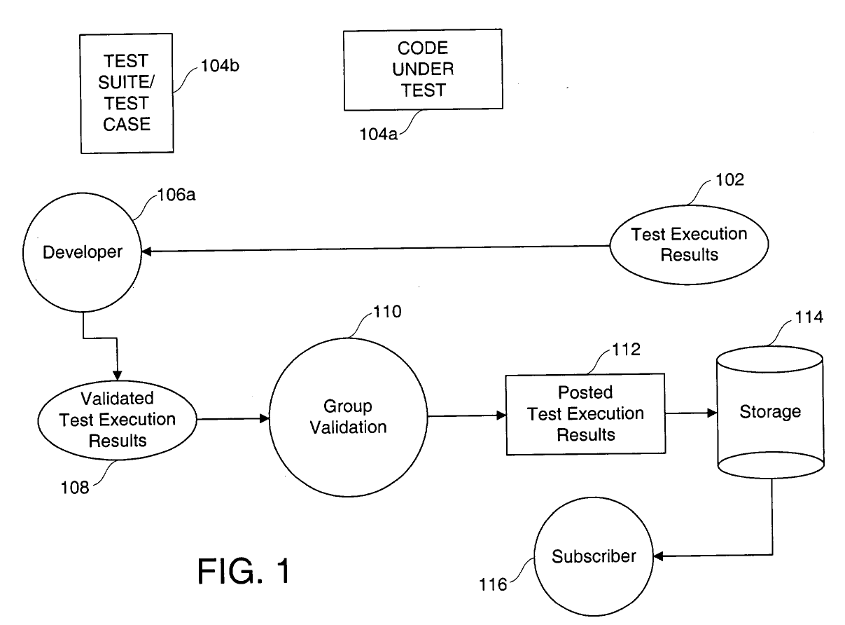

Keeping this brief overview to Enterprise Java Beans and Java in mind, reference is made to FIG. 1 illustrating generation of validated test execution results using a validation release structure, in accordance with one embodiment of the present invention. As shown, test execution results 102 are generated as a result of a test suite 104b, as created by a developer 106a is implemented to test a code under test 104a. In accordance with the embodiments of the present invention, the developer 106a, as the creator and thus the owner of test execution results 102, reviews test execution results 102, modifying same, if necessary. As shown, the developer 106a then releases validated test execution results 108 to the next person in the release structure. In accordance with the embodiments of the present invention, test execution results are validated (i.e., released) given that the generated test execution results are as intended.

At this point, in group validation 110, each of the members of the group, in accordance with a release structure, view, and validate the validated test execution results. Once each of the members of the group has reviewed and validated test execution results 108, the group validated test execution results are generated, which as shown, are posted as having a non-changeable status in the posted test execution results 112.

The posted test execution results 112 are then stored to storage 114, allowing a subscriber 116 to view the posted test execution results. In this manner, the developer 106a, the members of the group, every manager, the product manager, and the subscribers 116 can view and use the non-changeable, the posted test execution results 112. As the posted test execution results 112 are non-changeable, the embodiments of the present invention provide data that is stable and has a high degree of integrity. In this manner, the group manager can easily determine whether all test execution results have been collected and posted. Additional details regarding the validation process, group release structure, and group validation, are provided below.

By way of example, the validation process of the present invention can be implemented in a matrix organization, simplifying generation of reports containing high quality of data. As an overview, in a matrix organization, resource managers are responsible for managing members of groups and respective resources. The resource managers are further responsible for ensuring the availability of members of the groups as well the members' level and skills. The resources are defined in a resource pool for use by members of the groups. In one example, the resource managers may be contacted by individuals responsible for work elements, requesting access to certain resources.

In one embodiment, a matrix organization is set up in two dimensions. One axis is the organizational structure while the other is the work breakdown structure. In one example, the organization structure may be the traditional hierarchical structure of an organization in which supervisors report to the persons in charge in each department that, in turn, reports to a more centralized authority. In another embodiment, the organization structure may be more autonomous, such as, a resource manager structure wherein the resource manager is responsible for the training and availability of a certain category of resources.

The activity breakdown structure can be divided such that a top level is all the significant activities of the organization, a second level is a project level (e.g., having a single entry per project), and a third level is all the tasks within each project. One of ordinary skill in the art must appreciate that in a different embodiment, the activities of the organization can be divided into any number of appropriate levels. Each project is managed by a project manager, who in turn, reports to a more central authority.

In one instance, a matrix organization can be created by one or more project managers asking the resource managers for access to certain resources, so as to accomplish a project. Because the resources are obtained from variety of sources, however, prior to implementing the resources, the project managers need to be satisfied with the resources offered. In a like manner, the resource managers need to be content with the resources offered to a plurality of project mangers, often simultaneously and on a variety of projects.

In one example, resource collection by the project managers of the organization may have additional requirements. For instance, the project managers may need to find out which bugs have been found in each product. The project managers may also need to learn the extent of progress made in eliminating a particular bug or the extent of time required to eliminate each bug. As will be more described below, the embodiments of the present invention can be implemented to simplify report generation in matrix organizations while maintaining the high quality level.

In accordance with one exemplary embodiment, test execution results report is generated based on information validated by the test/test suite developers and the other individuals in the release structure. Initially, the developer analyzes test execution results and categorizes the results. Before forwarding test execution results to the next person in the release structure, if necessary, the developer modifies test execution. In one embodiment, the first individual examining test execution results is the developer who created the test/test suite. Thus, the release structure of the present invention beneficially allows test execution results to be easily and rapidly transmitted to the members of the group.

In one example, modifying test execution results includes removing of all significant test execution bugs and test scripting bugs and storing of the rejected test execution results in a separate storage. In this manner, rejected test execution results are available for further viewing or auditing by each individual in the group.

At this point, the developer can either validate (i.e., release) test execution results to the next person in the release structure or reject the test execution results to the previous person in the release structure. In one instance, releasing test execution results means that expected test execution results have been generated while rejecting test execution results means that a test script or an execution bug has occurred and that test execution results contain unexpected information. In the end, group validated test execution results are given non-changeable status by posting of the group validated test execution results. In this manner, prior to generating test execution results reports, all significant test execution bugs and test scripting bugs are removed and the rejected test execution results are stored in a separate storage.

Thus, the embodiments of the present invention enable a matrix organization to move test execution results rapidly, allow the project managers to modify test execution results without actually modifying the actual test execution result so as to maintain the originally generated test execution results for audit purposes, and maintain an audit trail line-by-line.

It must be noted that the number of layers in the release structures of the present invention can be any appropriate number of layers so long as rapid releasing of test execution results can be achieved. In this manner, the validation process occurs in a timely fashion producing validated test execution results that substantially reflect the actual test execution results. Furthermore, as the embodiments of the present invention allow validation per test suite, the embodiments of the present invention provide helpful information to the test suite developers.

Additionally, in one embodiment, the original owner of test execution results may erroneously reject test execution results for lack of understanding test execution results, a mistake, or forgetting to release same, etc. In this manner, the group manager may be allowed to release the rejected test execution results rejected by the original owner.

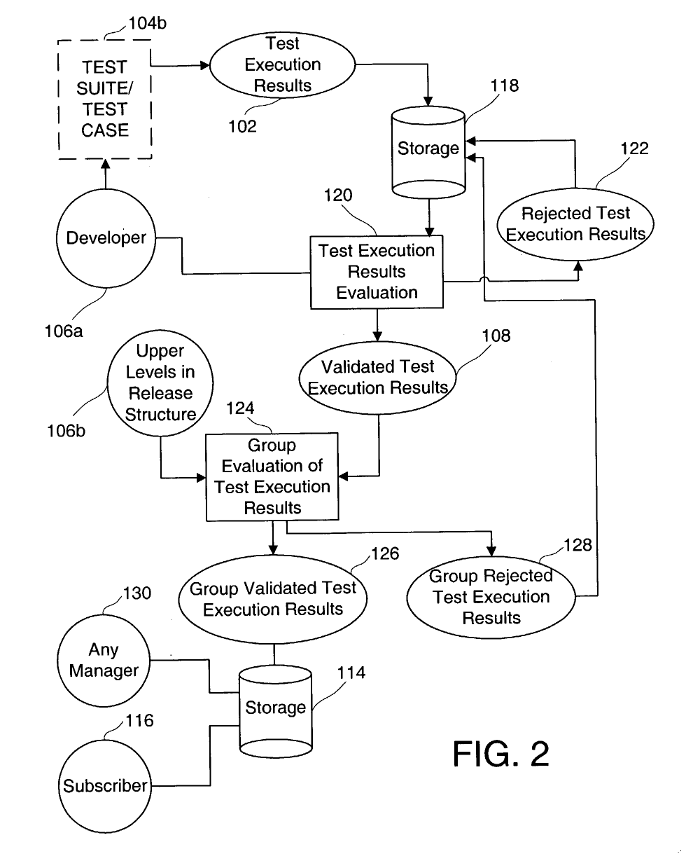

Reference is made to block diagram of FIG. 2, illustrating an exemplary validation process, in accordance with one embodiment of the present invention. The test suite 104b created by the developer 106a is used to test the code under test (not shown in this Figure), generating test execution results 102. In one embodiment, for ease of access in the future, test execution results 102 are stored to storage 118. As shown, the developer 106a uses test execution results 102 stored to storage 118 to evaluate test execution results in test execution results evaluation 120. In one example, the developer 106a views test execution results 102 attempting to locate all bugs and failures in same. For instance, test execution results 102 may include execution bugs resulting from improper setting up of the testing environment, product bugs usually found in the code under test, scripting bugs resulting from testing a code under test without having all of the required components, and test bugs resulting from a bug in the test suite being executed.

While reviewing test execution results 102 in test execution results evaluation 120, the developer 106a can modify test execution results 102 so as to eliminate all the bugs detected. At this point, the developer 106a can reject all or certain portions of test execution results, generating rejected test execution results 122, which as depicted, are stored to storage 118, for future access and viewing. In one example, the rejected test execution results 122 are available to the developer 106a, the original owner of test execution results and the other members of the release structure.

Once the developer 106a has concluded reviewing and modifying test execution results, the developer 106a releases validated test execution results 108. Subsequent to releasing the validated test execution results 108, the developer 106a can view the validated test execution results, however, the developer 106a can no longer make any modifications to the validated test execution results 108.

The validated test execution results 108 are then viewed by individuals in upper levels of release structure in group evaluation of the validated test execution results 124. As will be described in more detail below, in group evaluation of validated test execution results 124, in accordance with the group release structure, each of the members of the group views the validated test execution report 108, starting with the individual having the lowest level. Group validated test execution results 126 generated by the group validation of the validated test execution results 124 are then posted and stored to storage 114, allowing managers 130 and subscriber 116 to view the posted test execution results. Additional information regarding the release structure and validation process is provided below.

In one embodiment, the validation process of the present invention is implemented to rapidly validate test execution results in an exemplary software quality engineering (“SQE”) group. In one example, the validation process of the present invention can determine whether all test execution results to be used in generating the reports have been collected. Once such determination is made, test execution results are posted to a non-changeable status. In this manner, the number of bugs assessed by each individual in the SQE group is locked, providing the product manager non-changeable test execution results, creating the SQE Release Structure.

Once test execution results have been posted, test execution results become available for viewing by the other project managers. For instance, project managers may be provided test execution results report per project and task for bugs discovered in test execution results during the previous report date.

In one example, prior to posting test execution results, the project managers are given a grace period during which the project managers can make any changes necessary to test execution results. For instance, if the project managers locate a bug description in test execution results, the project managers are allowed to modify test execution results. The modifications can be added to the original test execution results reports and a complete audit of each modification per person is maintained. In this manner, the project managers can obtain and modify test execution results prior to test execution results being posted. In such scenario, the project manger can maintain test execution results for a period of time, grace period, prior to posting test execution results for viewing and use by others. Thus, the embodiments of the present invention enable a project manager to enter validated test execution results at a later time. In one embodiment, test execution results are beneficially updated in the next project management update period.

In one exemplary embodiment, the quality engineer (QE), quality engineer lead (QEL), development engineer (DE), first line QE manager (MQE), first line DE manager, QE manager, and program management /directors (PMD) of an exemplary QE group utilize types of information named in Table 1 to generate test execution results reports.

TABLE 1
Exemplary Information Utilized by Members of QE Group

| | QE | QEL | DE | MQE | MD | QEM | PMD |
|---|---|---|---|---|---|---|---|
| Test Suite | x | x | | | | | |
| Test Case | x | x | | | | | |
| Test Owner | x | x | | | | | |
| # Test | x | x | | | | | |
| Run(Predict) | | | | | | | |
| # Corrected | | x | | | | | |
| Bugs | | | | | | | |
| New Test | | | | | | x | |
| # Test Passed | | | | | | | |
| New | x | x | | | | | |
| Old | x | x | | | | | |
| Fixed | | x | | | | x | |
| # Test Failed | | | | | | | |
| New | x | | | | | x | |
| Old | x | | | | | x | |
| Description | x | | | | | | |
| Open since | | | | | | x | |
| Categories | | | | | | | |
| Configuration | x | | | | | | |
| Technical Area | x | | | | | | |
| # Existing Test | | | | | | x | |

In one example, the platform implemented to generate test execution results reports is the same as the platform implemented to execute the test/test suite. The subscribers to test execution results reports can select the level of detail for the rejected test execution results or generate test execution results reports based on a specific time frame. Additionally, test execution results reports can be generated as a bar chart, a strip chart, a table, etc. By way of example, the J2EE SQE test execution results report may include a table where rows represent the test suites and the columns represent different test configurations. In one instance, the table used by the members of the group cannot be published so as to be viewed by individuals outside the group (e.g., specifically the same format). In one embodiment, the J2EE SQE engineer may enter information by using the actual statusU tool or the Test Description JSP, etc.

In accordance with one embodiment, the table structure of the database table is simple, so as to expedite test execution results reports generation. The database is designed such that certain information (e.g., producer or original owner's password, etc.) is not provided to vendors and subscribers.

In one instance, the validation process is implemented in tools using Java Server Page (JSP) for automatic user interface (AUI) technology, XSLT. By way of example, the XSLT technology enables the customization of the user interface based on the database data. Applet and applications can be added when required. For example, Bug Traq has an Hyper Text Markup Language (HTML) interface as well as a Gill (application) interface. The producers' (i.e., original owners) profile is stored using Extensible Markup Language (XML). In one embodiment, the producer can change the producer's profile directly by editing the producer's XML file.

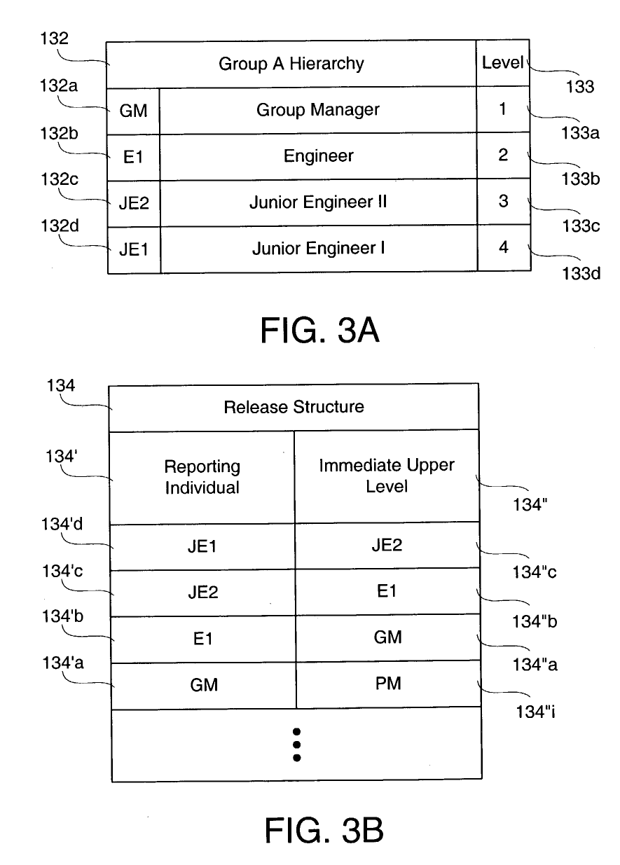

FIGS. 3A-3B illustrate an exemplary group hierarchy and release structure, in accordance with one embodiment of the present invention. As shown in FIG. 3A, a group “A” includes a group manager 132a, an engineer 132b, a junior engineer II 132c, and a junior engineer I 132d. The group manager 132a is shown to have a level 1 133a ranking designed to be the highest level ranking, while the engineer 132b is shown to have level 2 133b, the junior engineer II is shown to have the level 3 133c, and the junior level I is illustrated to have the level 4 133d, the lowest level ranking.

An exemplary release structure chart 134 is shown in FIG. 3B, in accordance with one embodiment of the present invention. As shown, the release structure chart 134 depicts each reporting individual 134′ in group “A” and the higher level individual 134″ to whom the validated test execution results should be released. As shown, a reporting individual junior engineer I 134′d releases the validated test execution results to junior engineer II 134″c (i.e., the individual having the immediate higher level ranking), a reporting individual junior engineer II 134′c releases the validated test execution results to engineer 134″b (i.e., the individual having the immediately higher level ranking), a reporting individual engineer 134″b releases the validated test execution results to group manager 134″a (i.e., the individual having the immediately higher level ranking). At this point, a reporting individual group manager 134′a posts the validated test execution results for viewing by the product manager 134″i and all other subscribers. Additional details regarding implementing the release structure 134 to generate non-changeable posted test execution results are provided below.

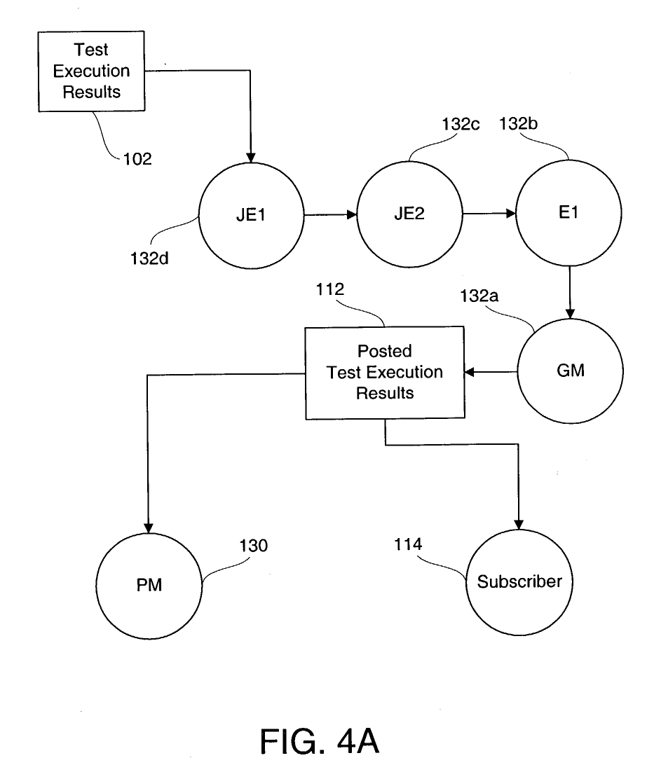

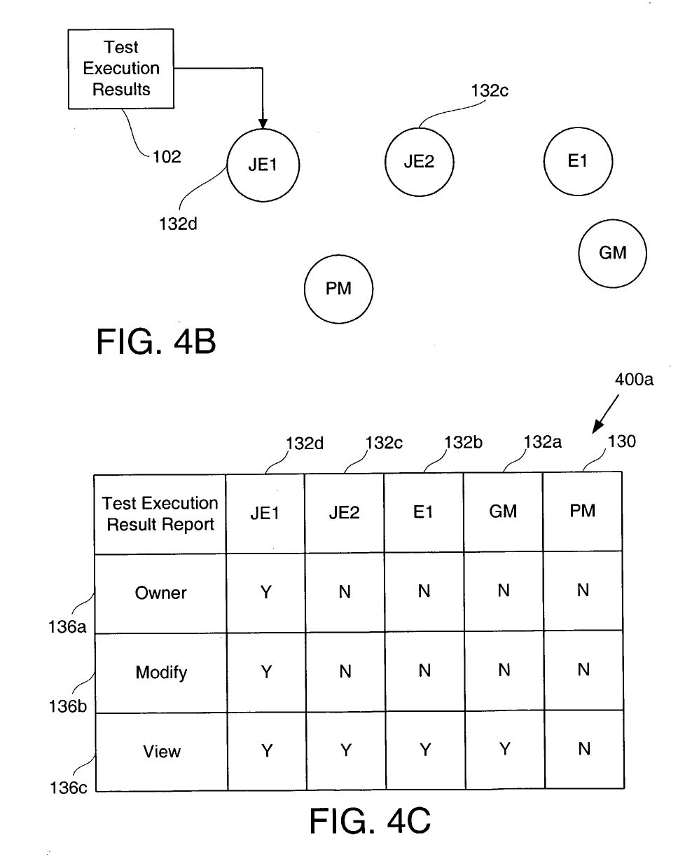

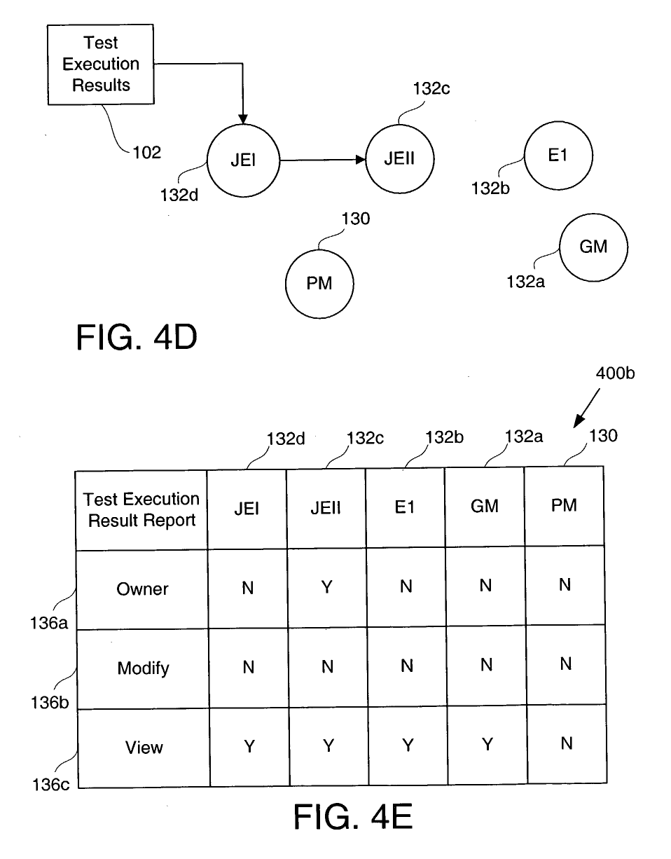

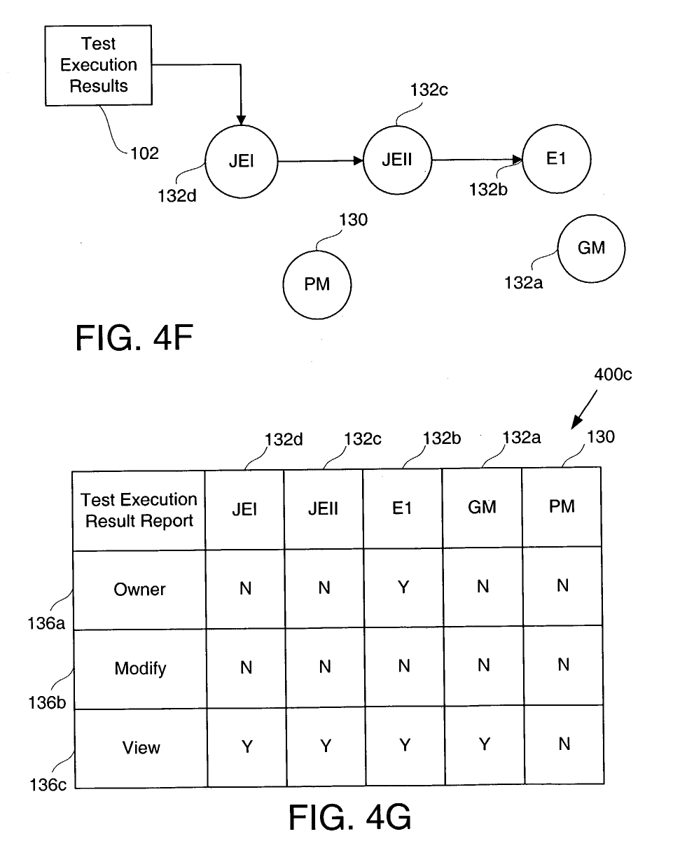

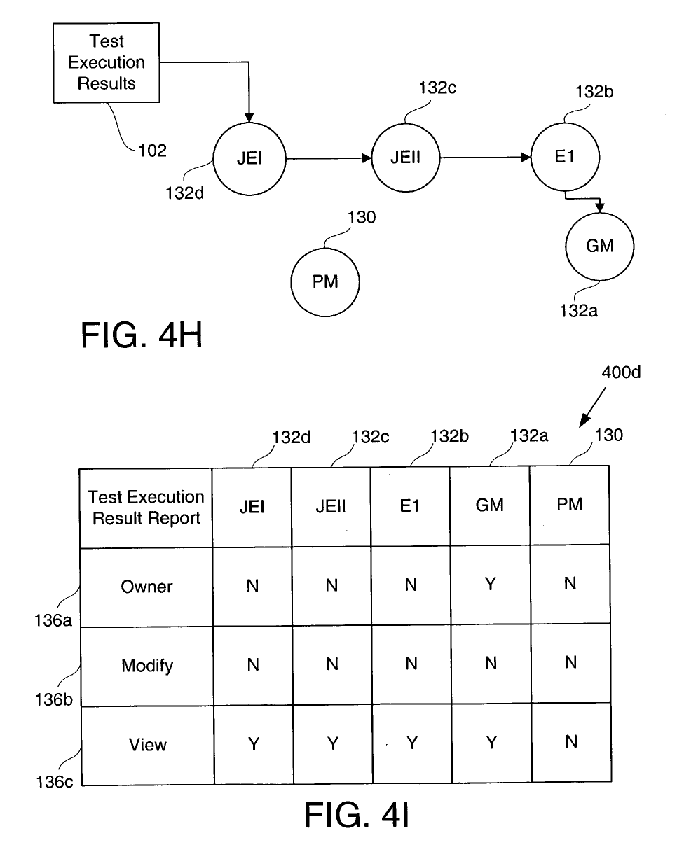

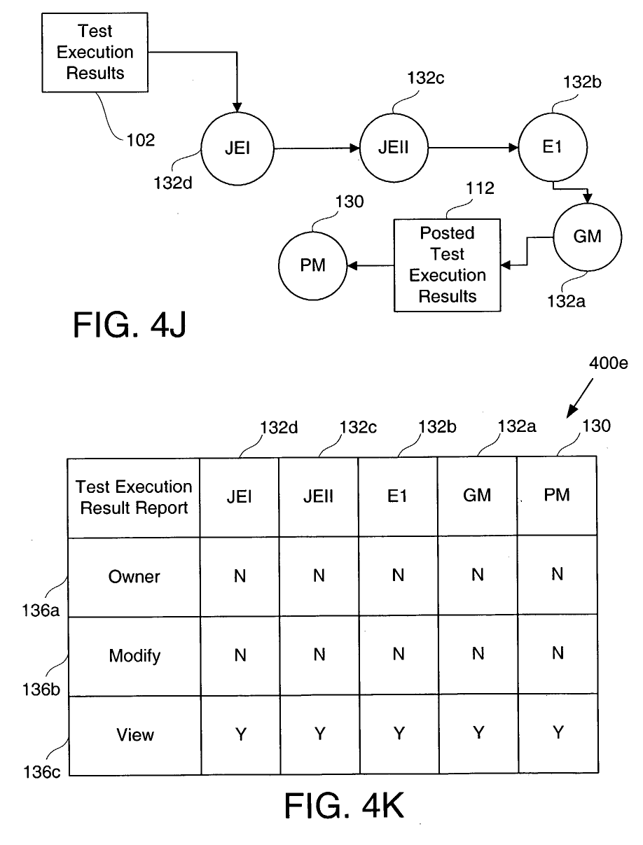

FIGS. 4A-4K are simplified block diagrams illustrating different stages of an exemplary validation process implemented by members of group A, in accordance with one embodiment of the present invention. As shown in the embodiment of FIG. 4A, test execution results 102 generated as a result of testing the code under test by the test suite 104b created by the junior engineer I 132d, is first viewed by the junior engineer I 132d. At this point, after reviewing/modifying test execution results 102, the junior engineer I 132d releases test execution results 102 to the next individual in the release structure (i.e., the junior engineer II 132c). In this manner, validated test execution results 102 is validated and thus rapidly made available for viewing by the junior engineer II 132c.

Thereafter, the junior engineer II 132c views the released test execution results. the junior level II 132c can either release the validated test execution results or reject same. The junior engineer II 132c is shown to have released the junior engineer II 132c version of the validated test execution results to the engineer 132b, next individual in the release structure 134. At this point, the engineer 132b reviews the validated test execution results, as received from the junior engineer 132c. Then, the engineer 132b releases the validated test execution results to the group manager 132a. Again, at this point, the group manager 132a reviews the test execution results and posts the group validated test execution results, generating the posted test execution results 112. At this point, the product manager 130 or the subscriber 114 can view the posted test execution results. As shown, the release structure of the present invention can be easily modified so as to allow the addition of extra layers (i.e., individuals) in the validation process.

FIGS. 4B-4K depict the validation process, as performed by each member of group A, in accordance with one embodiment of the present invention. As shown in FIG. 4B, the junior engineer I 132d obtains and views test execution results 102 generated as a result of testing the code under test using the test suite created by the junior engineer I 132d. In one example, the testing is performed using an automated testing system, which in one embodiment, runs nightly. Depending on the test suite, test execution results 102 may include pass, fail, or did not run entries. At this point, test execution results can be reviewed or modified by the developer 106a, so as to eliminate all test execution bugs.

As shown in a chart 400c, at this point of the validation process (i.e., point in the validation process prior to the junior engineer I 132d releasing the validated test execution results), the junior engineer I 132d is the original owner 136a of test execution results. As the original owner 136a, the junior engineer I 132d is capable of viewing and modifying test execution results. However, as shown in the embodiment of FIG. 4C, junior engineer II 132c, engineer 132b, group manager 132a, and product manager 130 are not the owners 136a of test execution results and cannot modify test execution results. Despite the fact that the junior engineer I and II 132d and 132c, engineer 132b, and group manager 132a (i.e., the members of group A) can view test execution results, the product manager 130 is not capable of viewing test execution results.

Continuing to the embodiment in FIG. 4D, the validated test execution results released by the junior engineer I 132d is then released to the next individual in the release structure, junior engineer II 132c. At this point, the junior engineer 132c becomes the owner of validated test execution results. This is illustrated in the chart 400′ of FIG. 4E, in which the owner 136a of the validated test execution results is shown to be the junior engineer II 132c. However, as shown, while the junior engineer II 132c can view test execution results, the junior engineer II 132c cannot modify test execution results. This occurs as the junior engineer II 132c is not the original owner. It must be noted that once the original owner 132d releases the test execution results 102, the engineer I can no longer modify the test execution results unless the test execution results are rejected by a higher ranking individual to the original owner for modification. Similarly, the junior engineer I 132d, the engineer 132b, and the group manager 132a can view the validated test execution results. As illustrated, the product manager 130 is still not able to modify or view test execution results, as validated by the junior engineer I 132d.

FIG. 4F depicts releasing of validated test execution results by the junior engineer II 132c to the engineer 132b, in accordance with one embodiment of the present invention. As shown, being the owner of test execution results, the engineer 132b can view test execution results. However, the engineer 132b cannot modify test execution results so as to eliminate execution bugs or failures in test execution results.

At this juncture, as shown in a chart 400c of FIG. 4G, the engineer 132b is the owner 136a of validated test execution results as validated by the junior engineer II 132c, and as such, can view the test execution results. Similarly, as shown, the junior engineer I and II 132d and 132c, and the group manager 132a can view test execution results, however, none of the junior engineer I and II 132d and 132c, and the group manager 132a is not a member of the group A, and as such, the group manager cannot view the test execution results at this point.

Proceeding to FIG. 4H, test execution results, as validated by the engineer 132b are released to the group manager 132a.As shown in FIG. 4I, the group manager 132a is the owner 136a of test execution results, and as such, can view the validated test execution results. In a chart 400d of FIG. 4I, the junior engineers I and II 132d and c, the engineer 132b can view test execution results. However, the junior engineers I and II 132d and c, the engineer 132b and the group manager 130 cannot modify the validated test execution results.

FIG. 4J depicts posting of group validated test execution results, in accordance with one embodiment of the present invention. As shown, in a chart 400e, after posting of group validated test execution results, the junior engineers I and II 132d and 132c, the engineer 132b, the group manager 132, and the product manager 130 can view the posted test execution results. However, none of the junior engineers I and II 132d and 132c, the engineer 132b, the group manager 132, and the product manager 130 can modify the posted test execution results.

In this manner, before the managers (e.g., subscribers) can have access to the nightly test/test suite execution results, the original owner has the opportunity to validate test execution results so as to decide the source of each bug (e.g., script bug, test bug, product bug, etc.) and to mark test execution results as validated for reporting. In this manner, before making test execution results available to the subscribers, the original user has the opportunity to either release or reject test execution results. The release test execution results are implemented to create the reports. The rejected test execution results are stored and as such can be used to create a test execution failure report, the original owner's test errors, etc. Additionally, the new original owners are allowed to release their test execution results to a more experienced individual in the group before releasing test execution results for viewing by others.

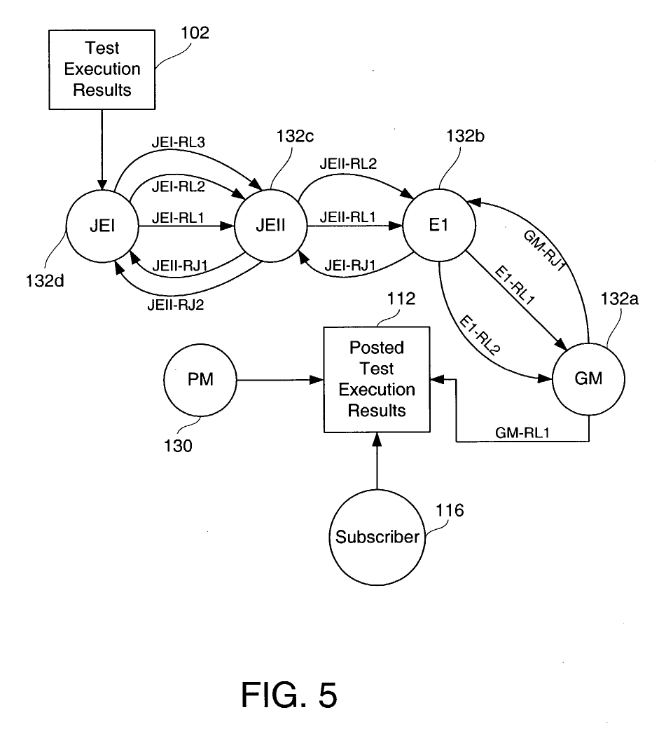

FIG. 5 depicts an exemplary validation process, in accordance with still another embodiment of the present invention. As shown, the junior engineer I 132d is provided test execution results 102 generated as a result of testing the code under test by the test suite created by the junior engineer 132d. Subsequent to viewing test execution results 102 and modifying same so as to eliminate any bugs or failures, the junior engineer I 132d releases the validated test execution results JE1-RL1 to the junior engineer II 132c, the next individual in the release structure.

At this point, the junior engineer 132c reviews the first validated test execution results JE1-RL1, finding unexpected results in test execution results JE1-RL1, as validated by the junior engineer I 132d. For instance, the unexpected results may be caused due to existence of a test, script, or execution bug in test execution results. At this point, the junior engineer II 132c is shown to have rejected the validated test execution results JE1-RL1, returning the rejected validated test execution results JE2-RJ1 to the previous owner, junior engineer I 132d.

At this point, the junior engineer I 132d again reviews the rejected validated test execution results JE2-RJ1 looking for any test, script, or execution bugs, previously undetected by the junior engineer I 132d. After eliminating the unexpected results pointed out by the junior engineer II 132c, the junior engineer I 132d releases a validated test execution results JE1-RL2. As illustrated, the validated test execution results JE1-RL2 are viewed by the junior engineer II 132c, followed by validation and release of the validated test execution results JE2-RL1 to the engineer 132b by the junior engineer 132c.

Then, the engineer 132b views the validated test execution results JE2-RL1, as validated by the junior engineer 132c, and releases the engineer 132b validated test execution result E1-RL1. The group manager 132a views the validated test execution results E1-RL1 finding the validated test execution results E1-RL1 less than adequate. For instance, the group manager 132a may find a test execution or a test scripting bug, thus rejecting rejected validated test execution results GM-RJ1 back to the engineer 132b.

Once the engineer 132b receives the rejected validated test execution results GM-RJ1, the engineer 132b views the rejected validated test execution results GM-RJ1 and rejects the rejected validated test execution results E1-RJ2 to the junior engineer II, who in turn rejects a rejected validated test execution results JEII-RJ2 to the junior engineer I 132d. The junior engineer I 132d then locates and eliminates the unexpected results, releasing a validated test execution results JEI-RL3 to the junior engineer II 132c. After reviewing the validated test execution results JEI-RL3, the junior engineer II 132c releases a validated test execution results JEII-RL2 to the engineer 132b. Thereafter, once again, the engineer 132b releases a validated test execution results E-RL2 to the group manager 132a.At this point, the group manager 132a reviews the validated test execution results E-RL2, attempting to locate any unexpected occurrences. Once the group manager 132a has satisfactory concluded the review of the validated test execution results E-RL2, the group manager 132a generates a group manager validated test execution results GM-RL1 and posts same, generating the posted test execution results 112. At this point, the subscriber 116 and the product manager 130 can view the posted test execution results 112.

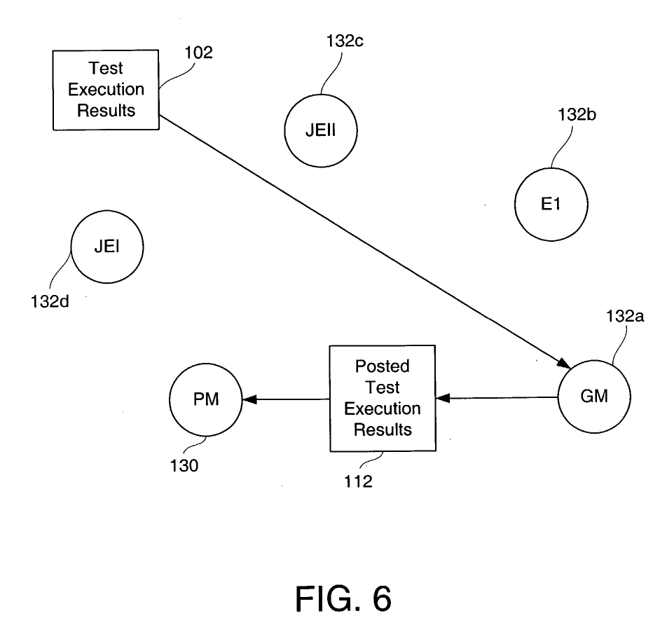

FIG. 6 depicts yet another exemplary validation process, in accordance with one embodiment of the present invention. As shown, test execution results 102 generated by testing the code under test using the test suite written by the junior engineer I 132d are ready for viewing and modification. However, the junior engineer I 132d is not available to review test execution results 102. As a result, in accordance with one embodiment of the present invention, the group manger 132a, the individual having the highest ranking in the release structure, is given clearance to view and modify, if necessary, test execution results 102. Thereafter, the group manager 132 releases the validated test execution results as posted test execution results 112. At this point, a product manager 130 or any subscriber can view the posted test execution results. Thus, the embodiments of the present invention beneficially provide a supervisor (e.g., group manager) the capability to view and directly release/reject test execution results for any of the members in the release structure, so long as that member has a lower ranking in the release structure.

It must be noted that that test execution results 102 may be stored in any appropriate data storage component (e.g., databases, file systems, tapes, etc.) Additionally, one of ordinary skill in the art must appreciate that test execution results may be stored to the data storage component using any appropriate data storage structure (e.g., databases, tables, etc.).

Furthermore, any automated reporting system implemented in a projectized environment can be configured to support the validation process of the present invention. Additionally, the embodiments of the present invention can be configured to use any commercial database so as to facilitate linking of pre-existing systems having pre-defined links to existing project management systems.

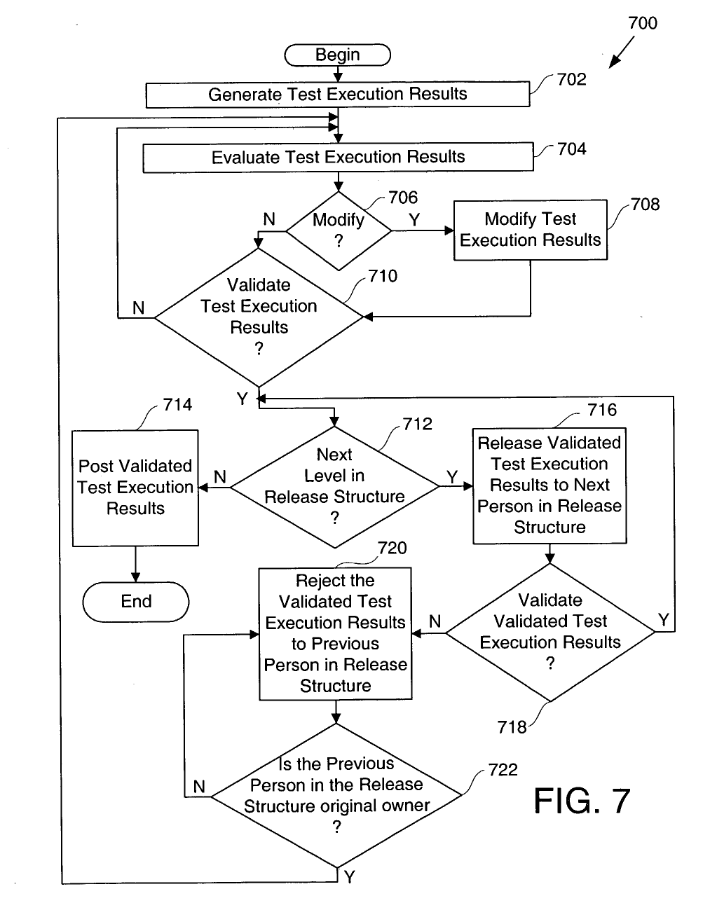

FIG. 7 depicts a flowchart 700 illustrating the method operations performed during an exemplary validation process, in accordance with one embodiment of the present invention. The method begins in operation 702 in which test execution results are generated followed by operation 704 in which test execution results are evaluated. In one exemplary embodiment, the producer (i.e., test owner) enters the tests into the test workspace for execution. The test execution process is performed nightly, for instance, and test execution results are stored in a test execution results space. In accordance with the embodiments of the present invention, test execution results can be generated in different forms and formats (e.g., XML files, text files, etc.). Furthermore, test execution results are stored in a persistent mechanism such as a database.

Proceeding to operation 706, a determination is made as to whether test execution results need to be modified. If it is determined that test execution results need to be modified, the method continues to operation 708, in which test execution results are modified. In one example, test execution results need to be modified so that execution bugs, product bugs, scripting bugs, or test bugs, can be eliminated from test execution results. If the determination is made that test execution results need not be modified, the method continues to operation 710 in which a determination is made as to whether test execution results can be validated. If the test execution results cannot be validated, the method continues to operation 704 in which test execution results are evaluated. In one exemplary embodiment, the producer (the original owner) is configured to validate the producer's test execution results and reject test execution errors or script errors.

If in operation 710 a determination is made that test execution results can be validated, the method continues to operation 712 in which it is determined whether the next level in release structure exists. If a next level in the release structure does not exist, the validated test execution results are posted for viewing in operation 714. Otherwise, the validated test execution results are released to the next level in the release structure in operation 716. In one example, the released test execution results are stored to a new persistent storage (e.g., a different database, etc.).

Proceeding to operation 718, a determination is made as to whether the validated test execution results can be released. If the validated test execution results can be released, the method continues to operation 718. However, if it is determined that the validated test execution results cannot be released, the validated test execution results is rejected to the previous person in the release structure. Thereafter, the method continues to operation 722 in which a determination is made as to whether the previous person in the release structure is the original owner. If the previous person in the release structure is the original owner, the method continues to operation 704. Otherwise, the method continues to operation 720. At this point, the subscribers (including the producer) can be advised that new test execution results are available for reporting. In one example, test execution results report is created using an individual profile.

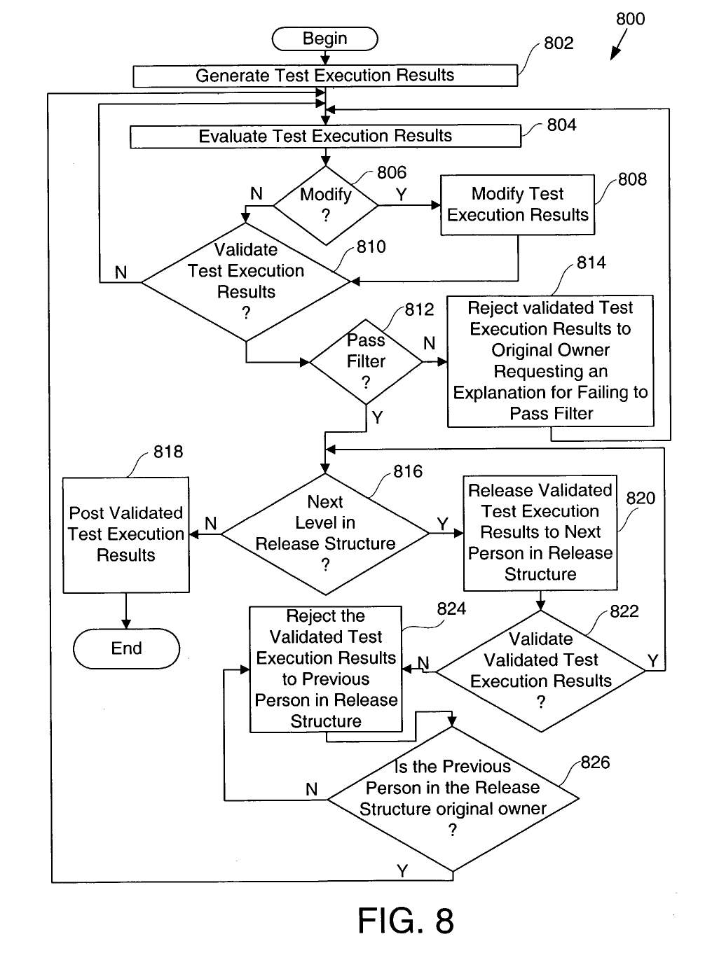

Reference is made to FIG. 8 depicting a flowchart 800 illustrating the method operations performed in an exemplary validation process implementing a filter, in accordance with one embodiment of the present invention. The method begins in operation 802 in which test execution results are generated followed by operation 804 in which test execution results are evaluated. Next, in operation 806 a determination is made as to whether test execution results need to be modified. If the test execution results need to be modified, the method proceeds to operation 808, in which test execution results are modified. In one example, test execution results need to be modified so that execution bugs, product bugs, scripting bugs, or test bugs, can be eliminated from test execution results. If the test execution results need not be modified, the method continues to operation 810 in which a determination is made as to whether test execution results can be validated. If the test execution results cannot be validated, the method continues to operation 804 in which test execution results are evaluated.

If in operation 810 a determination is made that test execution results can be validated, the method continues to operation 812 in which a determination is made as to whether the validated test execution results pass a filter. In one example, the filter is designed to prevent original owner of test execution results from validating test execution results not complying a selected criteria. For instance, in one example, the filter may be prohibiting validation of test execution results having more than a certain number of failures, bugs, or did not runs. Thus, it must be appreciated by one of ordinary skill in the art that the selected criteria may be any suitable criteria (e.g., including do not wish to generate a valid report, too many failures, too many did not runs, etc.).

If the validated test execution results do not pass the filter, the method continues to operation 814 in which the validated test execution results are rejected to the original owner requesting an explanation for the validated test execution results failing to pass the filter. However, if the validated test execution results pass the filter, the method continues to operation 816 in which it is determined whether the next level in release structure exists. If a next level in the release structure does not exist, the validated test execution results are posted for viewing in operation 818. However, if the next level in the release structure exists, the validated test execution results are released to the next person in the release structure in operation 820.

Proceeding to operation 822, a determination is made as to whether the validated test execution results can be released (i.e., validated). If the validated test execution results can be released, the method continues to operation 816. However, if the validated test execution results cannot be released, the validated test execution results are rejected to the previous person in the release structure in operation 824. Thereafter, the method continues to operation 826 in which a determination is made as to whether the previous person in the release structure is the original owner. If the previous person in the release structure is the original owner, the method continues to operation 804. Otherwise, the method continues to operation 824.

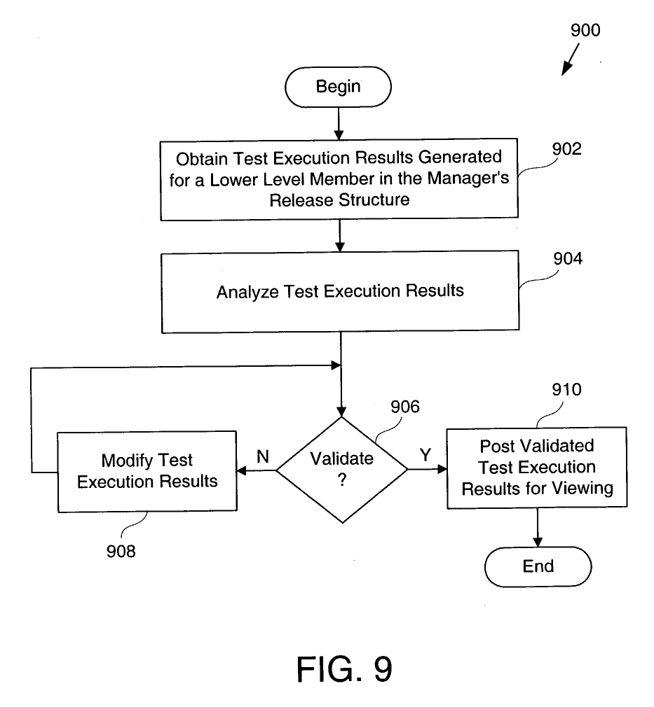

FIG. 9 depicts a flowchart 900 illustrating the method operations performed by a group manager during a validation process, in accordance with one embodiment of the present invention. The method begins in operation 902 in which test execution results for a lower level member in the manager's release structure is obtained. Then, in operation 904, test execution results are analyzed. Thereafter, in operation 906 a determination is made as to whether test execution results can be validated. If test execution results cannot be validated, the method continues to operation 908 in which test execution results are modified and the method continues to operation 906. If the test execution results can be validated, the method continues to operation 910 in which the validated test execution results are posted for viewing.

The advantages of the present invention are numerous. Most importantly, the embodiments of the present invention prevent introduction of inaccurate data by eliminating errors produced due to manually generating test execution results reports. Another advantage of the present invention is that test execution results can be entered directly into an automated system, allowing test execution results reports to be generated and transported to other systems in the organization effortlessly and promptly. Yet another advantage is that test execution results can be accessed rapidly. Still another advantage is that by entering test execution results reports into the automated systems, any scripting error, database setup errors, or any other inaccuracies in test execution results can be trapped prior to generating test execution results reports. Still another advantage of the present invention is eliminating the need to manually re-enter the generated test execution results into the automated systems. Yet another advantage is that the necessity to manually re-calculate test execution results failures/successes, remove test execution results failures, and other time-consuming tasks associated with the prior art has been eliminated. Still another advantage is that generation of test execution results reports is performed accurately while ensuring that all test execution results have been posted. Yet another advantage of the present invention is that automated systems can be implemented to generate reports, allowing the expected test execution results failures be compared with the actual test execution results reports, identifying any untested portion of the test suite. Still another advantage of the present invention is that the group managers can obtain test execution results timely. Yet another advantage is that test execution results report can be maintained simple, allowing the producer to remove, correct, or add comments easily and prior to generation of test execution results report generation.

Still another advantage of the present invention is that it can be ensured that all test/test suites have been tested and validated. Still another advantage of the present invention is that test execution results reports can be generated based on stable data having a high degree of integrity. Still another advantage of the claimed invention is ensuring that a full audit trail is maintained allowing prompt recognition of the source of test/test suite test execution results.

With the above embodiments in mind, it should be understood that, the invention may be practiced with other computer system configurations including hand-held devices, microprocessor systems, microprocessor-based or programmable consumer electronics, minicomputers, mainframe computers and the like. Furthermore, the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion. Furthermore, although the present invention implements Java programming language, other programming languages may be used to implement the embodiments of the present invention (e.g., C, C₊₊, any object oriented programming language, etc.).

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for generating accurate test execution results in accordance with a release structure, the method comprising:
receiving the test execution results;
inspecting the test execution results to create validated test execution results;
while the validated test execution results fail to satisfy a particular criteria, rejecting the validated test execution results back to an original owner to enable re-validation;
while a next level in a release structure exists,
releasing the validated test execution results to the next level in the release structure if the validated test execution results are acceptable; and
rejecting the validated test execution results to the original owner if the validated test execution results are unacceptable; and
posting the validated test execution results that were determined to be acceptable.

2. A method as recited in claim 1, wherein the operation of inspecting the test execution results to create validated test execution results includes,
evaluating the test execution results;
modifying the test execution results if the test execution results are unacceptable; and
releasing the test execution results as validated test execution results.

3. A method as recited in claim 1, wherein the operation of validating the test execution results to create validated test execution results is performed by the original owner.

4. A method as recited in claim 1, wherein a test execution result report is generated using a posted validated test execution results.

5. A method as recited in claim 1, wherein the criteria is including a greater number of test cases having one of a pass, fail, and did not runs status.

6. A method as recited in claim 1, wherein the original owner has a junior engineer ranking.

7. A method as recited in claim 1, wherein a person occupying a highest level of the release structure has a group manager.

8. A method as recited in claim 1, further comprising:
viewing the posted validated test execution results.

9. A method for validating results through an inspection hierarchy, the method comprising:
receiving the results;
inspecting the results to create validated results at a first level, while at the first level maintaining an exclusive ownership of the results;
as long as a second level in a release structure exists,
releasing the validated results to the second level in the release structure if the validated results are acceptable at the first level; and
rejecting the validated results if the validated results are unacceptable, the rejecting at the second level acting to send the results back to the first level; and
posting the validated results if determined to be acceptable at the second level.

10. A method as recited in claim 9, wherein the operation of inspecting the results to create validated results is performed by an original owner of the results at the first level.

11. A method as recited in claim 9, wherein the operation of validating the results to create validated results includes,
evaluating the results;
modifying the results if the results are unacceptable; and
releasing the results as validated results.

12. A method as recited in claim 9, wherein the operation of rejecting the validated results if the validated results are unacceptable includes,
returning the validated results to the original owner to enable modification so as to correct certain informalities.

13. A method as recited in claim 9, wherein members of a group respectively occupy levels of the release structure such that members having a higher ranking than the original owner occupy upper levels of the release structure.

14. A computer program embodied on a computer readable medium for validating results through an inspection hierarchy, the computer program comprising:
program instructions for receiving the results;
program instructions for inspecting the results to create validated results at a first level, while the first level maintaining an exclusive ownership of the results;
program instructions for releasing the validated results to the second level in the release structure as long a second level in a release structure exists and the validated results are acceptable at the first level;
program instructions for rejecting the validated results as long as the second level in the release structure exists and the validated results are unacceptable, the rejecting at the second level acting to send the results back to the first level; and
program instructions for posting the validated results if determined to be acceptable at the second level.

15. A computer program embodied on a computer readable medium as recited in claim 14, wherein the program instructions for inspecting the results to create validated results includes,
program instructions for evaluating the results;
program instructions for modifying the results if the results are unacceptable; and
program instructions for releasing the results as validated results.

16. A computer program embodied on a computer readable medium as recited in claim 14, wherein the program instructions for rejecting the validated results includes,
program instructions for returning the validated results to the original owner to enable modification so as to correct certain informalities.

17. A computer program embodied on a computer readable medium as recited in claim 14, further comprising:
program instructions for viewing the posted validated test execution results.

18. A method for validating results through an inspection hierarchy, the method comprising:
receiving the results;
inspecting the results to create validated results at a first level of a plurality of levels, while at the first level maintaining an exclusive ownership of the results;
as long as a remaining level of the plurality of levels in a release structure exists,
releasing the validated results to a first remaining level of the remaining level of the plurality of levels in the release structure if the validated results are acceptable at the first level of the plurality of levels; and
rejecting the validated results if the validated results are unacceptable, the rejecting at the remaining level of the plurality of levels acting to send the results back to the first level; and
posting the validated results if determined to be acceptable at the remaining level of the plurality of levels.

19. A method for validating results through an inspection hierarchy as recited in claim 18, wherein the operation of inspecting the results to create validated results is performed by an original owner of the results.

20. A method for validating results through an inspection hierarchy as recited in claim 18, wherein members of a group respectively occupy levels of the release structure such that members having a higher ranking than the original owner occupy upper levels of the release structure.
